(19) United States
(12) Patent Application Publication
(10) Pub. No.: US 2009/0019526 A1
(43) Pub. Date: Jan. 15, 2009

(54) ELECTRONIC CONFERENCE SERVER APPARATUS AND ELECTRONIC CONFERENCE SYSTEM

(75) Inventor: Naoto Fukushima, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/170,604

(22) Filed: Jul. 10, 2008

(30) Foreign Application Priority Data
Jul. 13, 2007 (JP) 2007-184792
Jul. 13, 2007 (JP) 2007-184801

(51) Int. Cl. G06F 21/00

(52) U.S. Cl. 726/3

(57) ABSTRACT

An electronic conference server apparatus is provided, which carries out proper access management over electronic data used at an electronic conference in accordance with an access authority of each participant in the electronic conference. A folder making portion makes a folder for each participant in the electronic conference, the folder being accessible only by the participant, in a participant data recording portion, and copies electronic data limited in access in accordance with an access authority level set for the participant, to the made folder. An access managing portion permits a participant's access to a folder that is made for the participant, but denies other participants' access to the folder.

### CROSS-NOTING PARAGRAPH

This Nonprovisional application claims priority under 35 U.S.C. §119(a) on Patent Application No. 2007-184792 filed in JAPAN on Jul. 13, 2007 and Patent Application No. 2007-184801 filed in JAPAN on Jul. 13, 2007 the entire contents of which are hereby incorporated herein by references.

### FIELD OF THE INVENTION

The present invention relates to an electronic conference server apparatus, and, more particularly, to an electronic conference server apparatus and an electronic conference system that carry out access management over electronic data used at an electronic conference and that is capable of carrying out access management over the electronic data even after the end of the electronic conference.

### BACKGROUND OF THE INVENTION

Electronic conference systems are coming into wide use in the trend of paperless transactions and work efficiency improvement.

In use of such an electronic conference system, conference material data, presentation data, etc., stored in an electronic conference server apparatus (hereinafter “electronic conference server”) is displayed on the monitor of a terminal device (hereinafter “PC”), and participants proceed with a conference while watching the conference material, etc., displayed on the monitor, using a chat function, a TV phone function, etc., provided by the electronic conference server, etc.

Techniques for improving the convenience of a user of such an electronic conference system have been suggested.

For example, Japanese Laid-Open Patent Publication No. 2003-140855 discloses a printer that is capable of automatically transferring unprinted electronic data out of electronic data distributed (transmitted) at an electronic conference to a participant who has retired from the conference when the participant has retired from the conference in progress (i.e., has logged out from the electronic conference system).

Japanese Laid-Open Patent Publication No. 2006-252519 discloses a multifunctional terminal device that is capable of automatically sending by e-mail electronic data distributed at an electronic conference to a person who failed to participate in the conference (absentee).

Techniques for preventing a leak of electronic data and electronic data printout distributed to attendees at an electronic conference, ordinary meeting, etc., have also been suggested.

For example, Japanese Laid-Open Patent Publication No. 2006-155380 discloses an image processing apparatus that is capable of deleting electronic data related to distributed materials stored in a server at the point in time of recovering the distributed materials from attendees after the end of a conference.

According to both techniques disclosed in Japanese Laid-Open Patent Publication Nos. 2003-140855, 2006-252519 and 2006-155380, however, electronic data, etc., are uniformly distributed to or recovered from participants in a conference.

This leads to a problem when electronic data used at an electronic conference is put under confidentiality management. The problem is such that if a participant P having an authority for access to the electronic data and a participant NP not having an authority for access to the electronic data are present simultaneously in the conference, the participant NP not having the access authority (permission) is not restrained from accessing the electronic data, and, as a result, the electronic data to be under confidentiality management cannot be managed properly.

In another problematic case, if certain electronic data is needed from the end of an electronic conference until reopening of the conference to discuss a matter that was on the agenda at the conference, participants have to access electronic data even after the end of the conference.

Meanwhile, the organizer of the electronic conference needs to limit access to electronic data used exclusively at the conference, such as electronic data containing indefinite data, after the end of the conference. In other words, the organizer must recover such electronic data.

Following the end of an electronic conference, if access to electronic data used at the conference is permitted uniformly, access to certain electronic data to be put under access limitation is also allowed uniformly. On the contrary, if access to the electronic data is limited uniformly, access to certain electronic data to be accessed is also blocked uniformly. This brings a need of managing access to electronic data used at the electronic conference after the end of the conference for each piece of electronic data.

The above problems apply also to a participant who has a phased access authority corresponding to a confidentiality level (secrecy, strict confidence, etc.) of electronic data.

### SUMMARY OF THE INVENTION

An object of the present invention is to provide an electronic conference server apparatus and an electronic conference system that carry out proper access management over electronic data used at an electronic conference in accordance with an access authority of each participant in the electronic conference.

Another object of the present invention is to provide an electronic conference server apparatus and an electronic conference system that carry out proper confidentiality management over electronic data accessed at an electronic conference in accordance with an access authority of each participant in the electronic conference, and that carry out proper access management over each piece of electronic data after the end of the electronic conference.

A further object of the present invention is to provide an electronic conference server apparatus comprising an access authority level setting portion that sets an access authority level in access to electronic data used at an electronic conference for each participant in the electronic conference; a confidentiality level setting portion that sets a confidentiality level for each piece of electronic data used at the electronic conference; and an access managing portion that manages permission and denial of access to the electronic data based on a correspondence relation between the access authority level and the confidentiality level, wherein at the electronic conference, the participant's access to the electronic data is limited in accordance with the access authority level set for the participant.

A further object of the present invention is to provide an electronic conference server apparatus comprising an access authority level setting portion that sets an access authority level in access to electronic data used at an electronic conference for each participant in the electronic conference; a confidentiality level setting portion that sets a confidentiality level and a need/needlessness of electronic data recovery for each piece of electronic data used at the electronic conference; and an access managing portion that manages permission and denial of access to the electronic data based on a correspondence relation between the access authority level and the confidentiality level, wherein at the electronic conference, the participant's access to the electronic data is limited in accordance with the access authority level set for the participant, and wherein after the end of the electronic conference, the access to the electronic data is limited in accordance with whether the electronic data need to be returned or not as set for the electronic data.

A further object of the present invention is to provide the electronic conference server apparatus further comprising a participant registering portion that registers a participant in an electronic conference; and a participant authenticating portion that authenticates a participation qualification of a person who intends to participate in the electronic conference based on presence/absence of registration of the person with the participant registering portion, wherein only the person whose participation qualification is authenticated is allowed to access the electronic data everytime an electronic conference is held.

A further object of the present invention is to provide the electronic conference server apparatus wherein when a person not registered with the participant registering portion tries to access the electronic data, if the access authority level setting portion sets an access authority level for the person, the person is allowed to access the electronic data that is limited in access in accordance with the set access authority level.

A further object of the present invention is to provide the electronic conference server apparatus wherein the access managing portion makes a folder for each participant in the electronic conference as a folder accessible only by the participant, and copies the electronic data limited in access in accordance with the access authority level set for the participant, to the folder.

A further object of the present invention is to provide the electronic conference server apparatus wherein the access managing portion permits access to the electronic data only during an electronic conference.

A further object of the present invention is to provide the electronic conference server apparatus wherein the access managing portion makes a folder for each participant in the electronic conference as a folder accessible only by the participant, copies the electronic data limited in access in accordance with the access authority level set for the participant, to the folder, and, after the end of the electronic conference, deletes a piece of electronic data set to need to be returned, of the electronic data in the folder.

A further object of the present invention is to provide the electronic conference server apparatus wherein the access managing portion forbids access to the folder after the electronic conference is finished completely.

A further object of the present invention is to provide an electronic conference system comprising the electronic conference server apparatus; and an electronic conference terminal device connected to the electronic conference server apparatus via a network, the terminal device transmitting input personal information of the participant in the electronic conference to the electronic conference server apparatus.

### BRIEF DESCRIPTION OF THE DRAWINGS

FIG. 1 is a schematic diagram for explaining an electronic conference system;

FIG. 2A is a block diagram of an electronic conference server;

FIG. 2B is a block diagram of a PC;

FIG. 3 depicts a participant registration table;

FIG. 4 depicts an access authority level setting table;

FIG. 5 depicts a confidentiality level setting table;

FIG. 6A is a flowchart for explaining a process of setting an access authority level, etc.;

FIG. 6B is a flowchart for explaining a participant authentication process;

FIG. 6C is a flowchart for explaining management of access to folders;

FIG. 7 is another block diagram of the electronic conference server;

FIG. 8 depicts a confidentiality level and recovery need/needlessness setting table;

FIG. 9A is a flowchart for explaining a process of setting an access authority level, etc.;

FIG. 9B is a flowchart for explaining a participant authentication process; and

FIG. 9C is a flowchart for explaining management of access to folders and an electronic data recovery process.

### PREFERRED EMBODIMENTS OF THE INVENTION

### First Embodiment

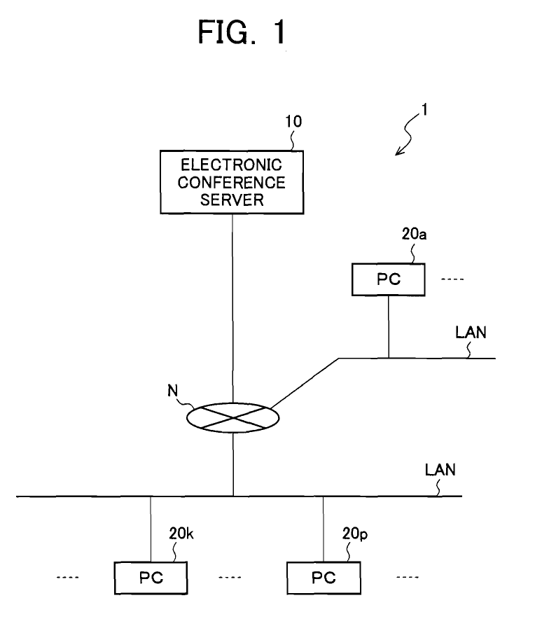

FIG. 1 is a schematic diagram for explaining an electronic conference system according to the present invention.

In FIG. 1, 1 denotes the electronic conference system, which includes an electronic conference server (electronic conference server apparatus) 10, and PCs 20a-20k-20p-. The electronic conference server 10 is connected to the PC 20a and other PCs via a LAN and a network N.

The electronic conference server 10 offers a general electronic conference function, and further manages access to electronic data, such as conference material data which is recorded on an HDD (Hard Disk Drive) in the electronic conference server 10 to be browsed at an electronic conference.

The PC 20a and other PCs are electronic conference terminal devices, i.e., client PCs that are allocated for each participant in an electronic conference. Each participant in the conference is allowed to access electronic data by using the electronic conference function of the electronic conference server 10 via the allocated PC.

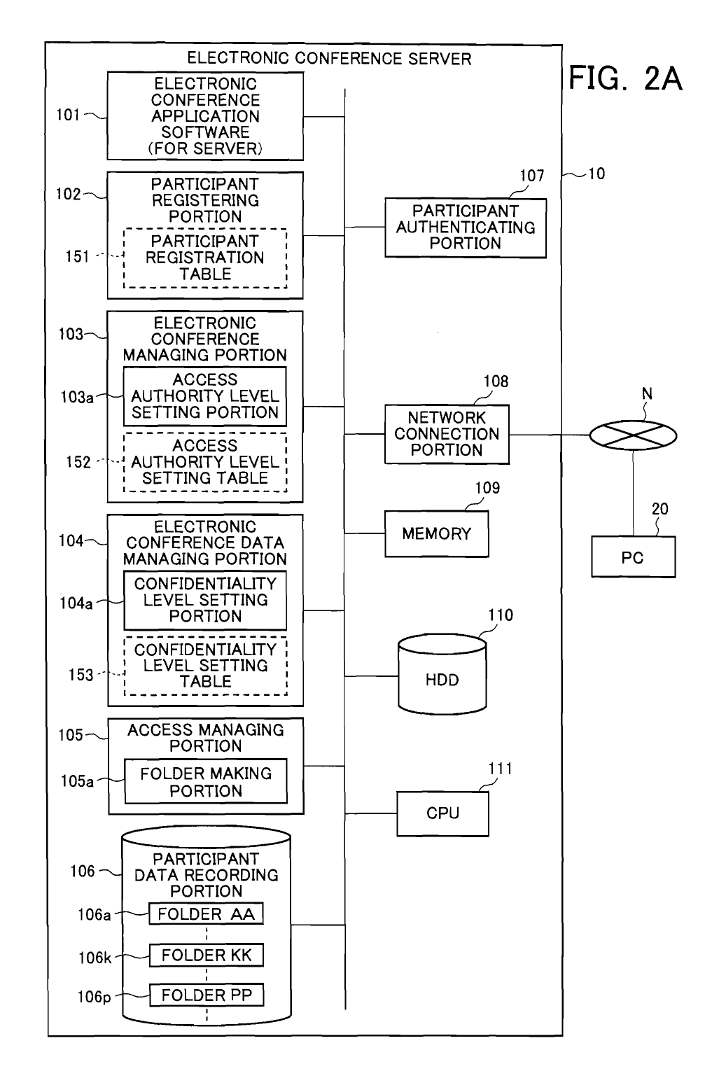

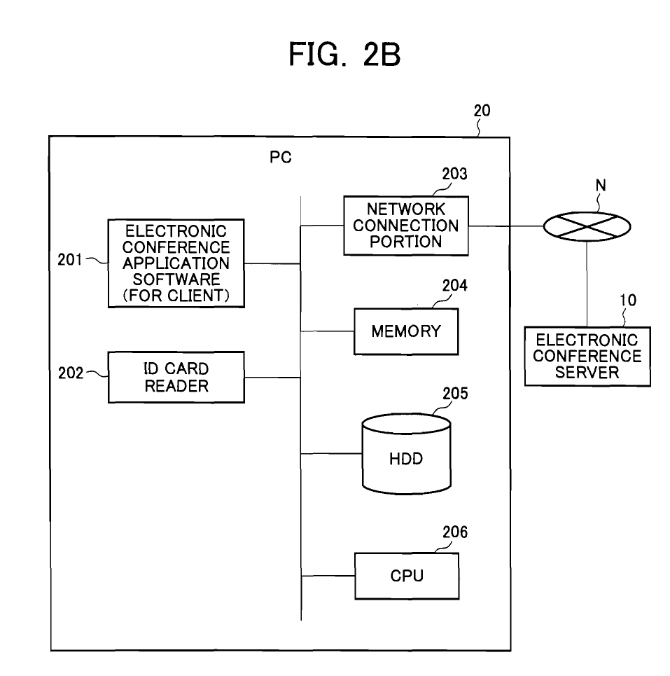

FIG. 2A is a block diagram of the electronic conference server 10, and FIG. 2B is a block diagram of the PC 20a (hereinafter “PC 20”).

### [Electronic Conference Server 10]

In FIG. 2A, 101 denotes electronic conference application software (for server). The electronic conference application software 101 is the software for holding an electronic conference-using a chat function, TV phone function, etc., allowing a participant in the conference to talk to another participant by the use of the chat function, etc.

### (Registration of Participant in Electronic Conference)

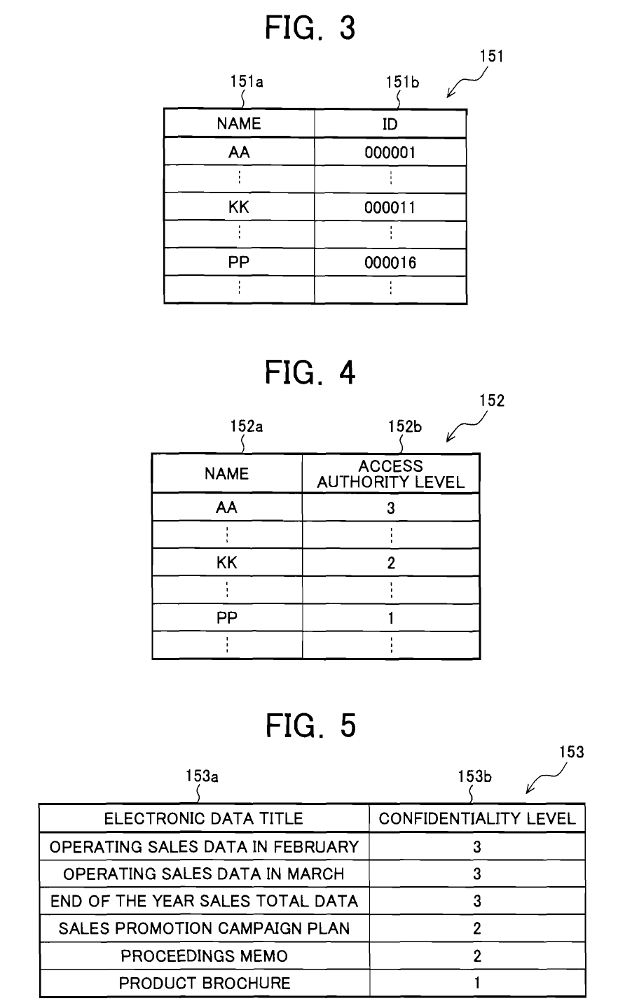

102 denotes a participant registering portion. The participant registering portion 102 updates and manages a participant registration table 151 shown in FIG. 3. Every time an electronic conference is newly held, the participant registering portion 102 executes a process of registering the name and ID of a participant in the conference that are input by the conference organizer (person in charge of expediting the proceedings or chairman) through a keyboard/mouse, etc., (not shown). In other words, the participant registering portion 102 registers the name and ID of the participant, which are input by the organizer, in a name column 151a and an ID column 151b of the participant registration table 151.

Following the registration, the participant in the electronic conference is authenticated with reference to the participant registration table 151, which will be described later.

The participant registration table 151 is updatable. For example, in such a case where the second conference is started following the end of the first conference, a new participant in the conference can be additionally registered with the registration table 151 every time an ensuing conference is held. Besides, a participant who has been registered at the previous conference may be removed from the registration table 151 (deletion of a participant from the participant registration table 151) when participants are limited as needed.

103 denotes an electronic conference managing portion. The electronic conference managing portion 103 has an access authority level setting portion 103a that, every time an electronic conference is held, sets an access authority level for access to electronic data used at the conference for each participant in the conference. The electronic conference managing portion 103 updates and manages an access authority level setting table 152 shown in FIG. 4.

### (Access Authority Level)

An access authority level is set for each electronic conference and for each participant in the electronic conference, and indicates a level (range) of accessibility to electronic data used at the electronic conference.

The access authority level is, for example, information expressed by a numerical value, etc. Here, a larger numerical value as an access authority level allows access to electronic data at a higher confidentiality level (confidentiality management level), such as conference material data (which means that the number (type) of accessible electronic data is greater). A specific example of an access authority level will be described later.

### (Setting of Access Authority Level)

The electronic conference managing portion 103 registers the name of a participant, which has been registered by the participant registering portion 102, in a name column 152a of the access authority level setting table 152 of FIG. 4.

Then, every time an electronic conference is newly held, the access authority level setting portion 103a executes a process of setting an access authority level, which is input by the conference organizer through a keyboard, etc., (not shown), for each participant in the conference. In other words, the access authority level setting portion 103a sets the access authority level for each participant, which is input by the organizer, on an access authority level column 152b of the access authority level setting table 152.

The access authority level is described more specifically by referring to FIG. 4. For example, according to FIG. 4, access authority levels “3” and “1” are set for a person AA and a person PP, respectively, by the organizer. As a result, the person AA is allowed to access electronic data at a higher confidentiality level in comparison with the person PP.

According to the present invention, access management over electronic data is carried out based on the above access authority level and a confidentiality level set for electronic data, which will be described later.

When a new participant in a conference is registered on the participant registration table 151, as described above, the participant is then registered in the name column 152a of the access authority level setting table 152, where the access authority of the participant is set by the organizer of the conference.

However, when a participant who has been registered at the previous conference is deleted this time from the participant registration table 151, the participant is not deleted from the name column 152a of the access authority level setting table 152. This is because that keeping the registration in name column 152a improves convenience when the deleted participant is registered again.

104 denotes an electronic conference data managing portion. The electronic conference data managing portion 104 has a confidentiality level setting portion 104a that sets a confidentiality level for electronic data, and updates and manages a confidentiality level setting table 153 shown in FIG. 5. Electronic data is recorded on an HDD 110.

### (Confidentiality Level)

A confidentiality level indicates a level of confidentiality management over electronic data, and is set for each piece of electronic data.

The confidentiality level is, for example, information expressed by a numerical value, etc. Here, a larger numerical value represents a higher confidentiality level, that is, a need for strict confidentiality management. A specific example of a confidentiality level will be described later.

### (Setting of Confidentiality Level)

The electronic conference data managing portion 104 executes a process of setting the title of electronic data used at an electronic conference, the title being input by the conference organizer through a keyboard, mouse, etc., (not shown). In other words, the electronic conference data managing portion 104 sets the title of electronic data in an electronic data title column 153a of the confidentiality level setting table 153 of FIG. 5.

Then, the confidentiality level setting portion 104a executes a process of setting a confidentiality level, which is input by the conference organizer through the keyboard, mouse, etc., (not shown), for each piece of electronic data. In other words, the confidentiality level setting portion 104a sets the confidentiality level in a confidentiality level column 153b of the setting table 153.

In FIG. 5, a confidentiality level “3” (e.g., level of strict confidence) is set for “operating sales data in February”, a confidentiality level “2” (e.g., level of handle with care) is set for “sales promotion campaign plan”, and a confidentiality level “1” (e.g., level of normal confidence) is set for “product brochure”, by the organizer. 105 denotes an access managing portion. The access managing portion 105 has a folder making portion 105a, which will be described later. At an electronic conference, the access managing portion 105 manages the permission and denial of access by a participant in the conference to electronic data based on the correspondence relation between an access authority level and a confidentiality level.

The access managing portion 105 carries out access management so that a participant is allowed to access only the electronic data at a set confidentiality level that is equal to or lower than an access authority level set for the participant.

An example of a process of implementing the access management will be described.

### (Making of Data Recording Folder)

The folder making portion 105a makes a folder for each participant in an electronic conference, the folder being accessible only by the participant, in a participant data recording portion 106 composed of an HDD, etc., in certain timing, for example, when the access authority level setting process for all participants in the electronic conference is over. In other words, the folder making portion 105a makes a data recording folder for each participant in the conference set in the name column 152a of the access authority level setting table 152 of FIG. 4.

The folder making portion 105a then copies electronic data limited in access in accordance with an access authority level set for the participant, to the made folder. Here, the folder making portion 105a copies electronic data at a confidentiality level that is equal to or lower than the access authority level set for the participant relevant to the made folder.

Specifically, the folder making portion 105a makes a folder for a participant with the access authority level 3 (e.g., person AA of FIG. 4) in the participant data recording portion 106 (folder AA 106a of FIG. 2A), and copies not only electronic data at the confidentiality level 3 (“operating sales data in February” of FIG. 5, etc.) but also electronic data at the confidentiality level 2 (“sales promotion campaign plan” of FIG. 5, etc.) and the same at the confidentiality level 1 (“product brochure” of FIG. 5), to the made folder.

The folder making portion 105a also makes a folder (folder KK 106k of FIG. 2A) for a participant with the access authority level 2 (e.g., person KK of FIG. 4), and copies electronic data at the confidentiality level 2 and the same at the confidentiality level 1 to the made folder.

Similarly, the folder making portion 105a also makes a folder (folder PP 106p of FIG. 2A) for a participant with the access authority level 1 (e.g., person PP of FIG. 4), and copies electronic data at the confidentiality level 1 to the made folder.

### (Access Management to Folder)

The access managing portion 105 permits a participant's access to a folder that is made for the participant but denies the other participants' access to the folder.

In this manner, at an electronic conference, access by a participant in the conference to electronic data is limited in accordance with an access authority individually set for the participant.

In the above case, access limitation is carried out so that only the participant AA is allowed to access the folder AA 106a.

In managing access to folders, various conventional methods can be adopted.

107 denotes a participant authenticating portion. The participant authenticating portion 107 authenticates the participation qualification of a person who intends to participate in an electronic conference, based on personal information (name and ID number) of the person and the presence/absence of registration of the person with the participant registration table 151 managed by the participant registering portion 102.

Every time an electronic conference is held, only the person whose participation qualification is authenticated is allowed to access electronic data that is copied to a folder for the person as a participant, as described above.

When a person intending to participate in an electronic conference inserts an ID card storing personal information including at least the person's name or ID number into an ID card reader (ID card reading device) 202 provided on the PC 20 allocated to the person, the ID card reader 202 reads the personal information and transmits the read personal information to the participant authenticating portion 107.

If the name and ID number contained in the personal information match the name and ID number registered in the name column 151a and ID column 151b of the participant registration table 151, the participant authenticating portion 107 receiving the personal information authenticates the person's qualification for participation in the electronic conference, thus approves the person's participation in the conference. Then, the person is allowed to access a folder that is made for the person, as described above.

If the matching in name and ID number does not occur, the participant authenticating portion 107 denies the person's participation, and notifies the conference organizer of the denial.

108 denotes a network connection portion that functions as an interface for connection to the network N and LAN.

109 denotes a memory having recorded thereon various control information, etc.

111 denotes a CPU (control portion) that controls each of functional blocks.

### [PC 20]

201 denotes electronic conference application software (for client). The electronic conference application software 201 uses the chat function, etc., offered by the electronic conference application software (for server) 101 of the electronic conference server 10 to execute a process of allowing one participant to talk to another participant in a conference and of accessing electronic data recorded in a folder that is made for each participant in the participant data recording portion 106.

The ID card reader 202 reads personal information stored in the ID card, and outputs the read personal information to a network connection portion 203. Upon receiving the personal information, the network connection portion 203 transmits the personal information to the network connection portion 108 of the electronic conference server 10 that is connected to the PC 20 via the network N. In other words, the PC 20 transmits personal information of a participant in an electronic conference that is input to the PC 20, to the electronic conference server 10.

The network connection portion 108 receiving the personal information outputs the personal information to the participant authenticating portion 107, and the participant authenticating portion 107 then carries out the authenticating process as described above.

204 denotes a memory having recorded thereon various control information, etc.

205 denotes an HDD having recorded thereon operation software, application software, etc.

206 denotes a CPU (control portion) that controls each of functional blocks.

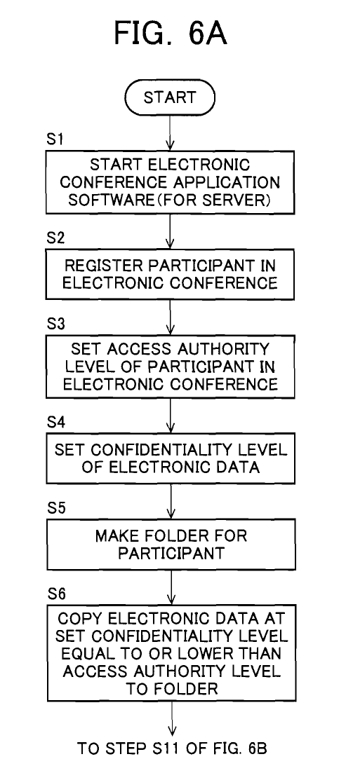

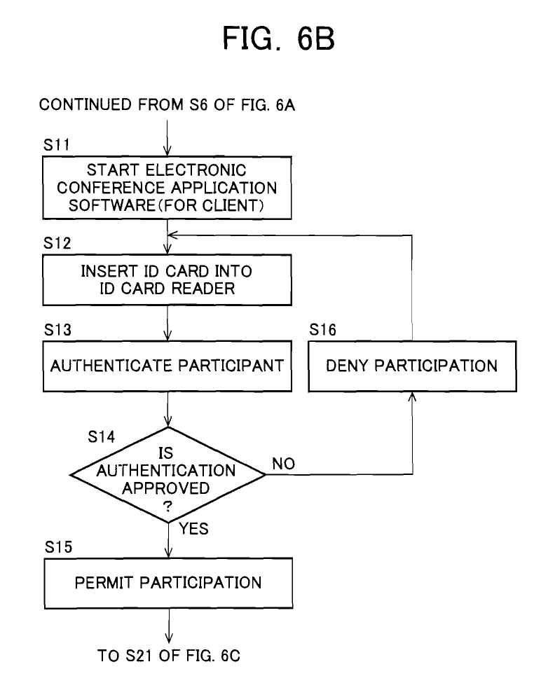

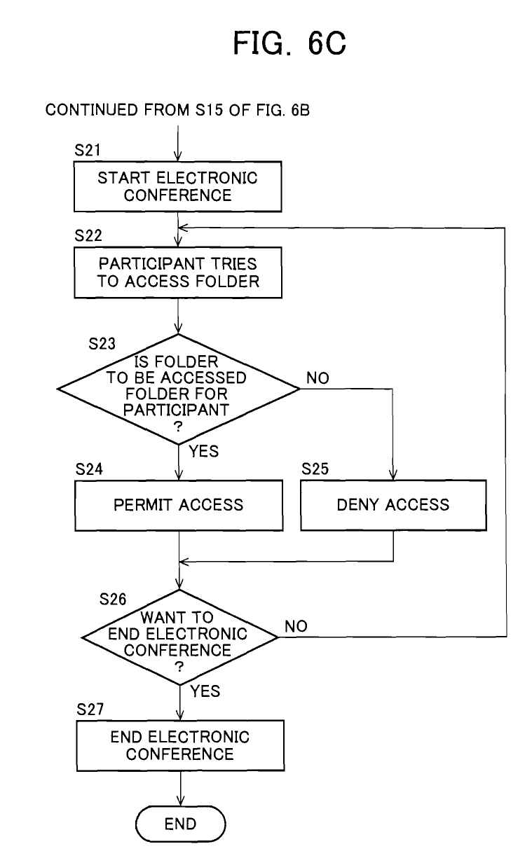

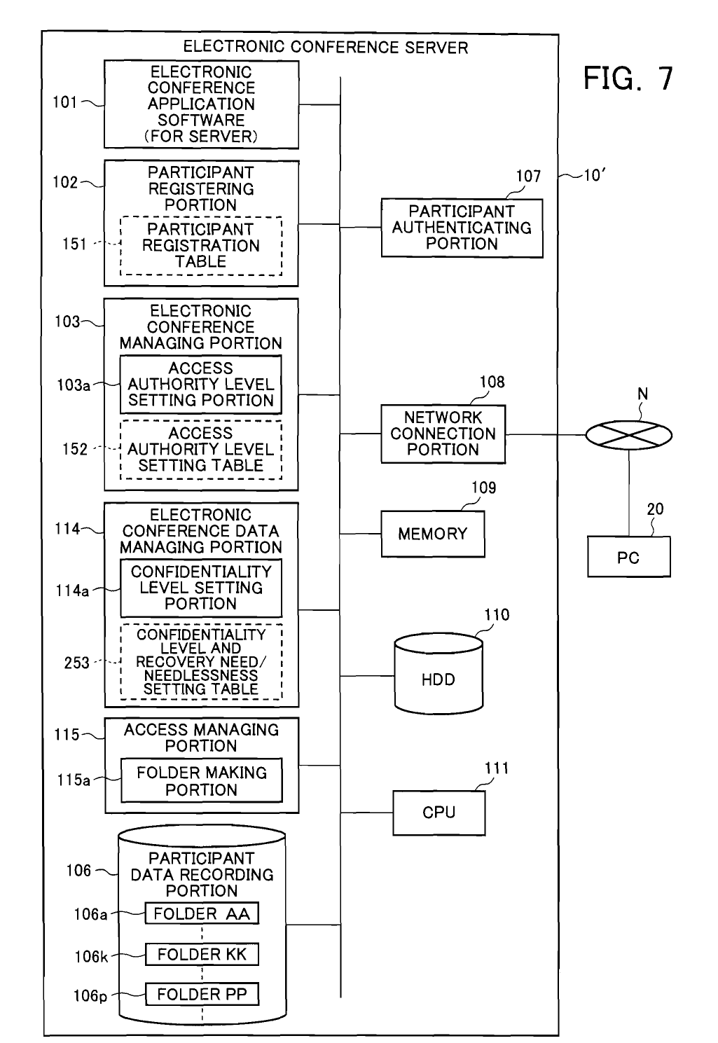

An example of a series of processes of setting the above mentioned access authority, etc., and starting and ending an electronic conference will be described referring to flowcharts of FIGS. 6A to 6C.

First, at step S1 of FIG. 6A, the organizer of an electronic conference starts the electronic conference application software (for server) 101.

Then, the names and IDs of all participants in the electronic conference are input through a keyboard, etc., to register the participants in the conference (step S2).

Likewise, an access authority level is set for each of the registered participants (step S3), and a confidentiality level is set for each piece of electronic data (step S4).

This means that the participant registering portion 102, the access authority level setting portion 103a, and the confidentiality level setting portion 104a set the names, access authority levels, confidentiality levels, etc., of the participants on the corresponding columns of the participant registration table 151, the access authority level setting table 152, and the confidentiality level setting table 153, respectively.

Then, the folder making portion 105a of the access managing portion 105 makes a data recording folder for each participant in the conference in the participant data recording portion 106 (step S5), and copies electronic data at a set confidentiality level equal to or lower than an access authority level set for each participant, to the folder made at step S5 (step S6).

At step S11 of FIG. 6B, a participant in the electronic conference starts the electronic conference application software (for client) 201 of the PC 20 allocated to the participant, and inserts the ID card of the participant into the ID card reader 202 (step S12).

Subsequently, the participant authenticating portion 107 of the electronic conference server 10 authenticates the participant (step S13), and when approving the authenticity of the participant (YES at step S14), permits the participant's participation in the conference (step S15).

When not approving the authenticity of the participant (NO at step S14), the participant authenticating portion 107 denies the participant's participation (step S16).

When authentication of all participants is over, the organizer of the electronic conference starts the conference at step S21 of FIG. 6C.

During the conference, when a participant tries to access a folder recording electronic data (step S22), the access managing portion 105 determines whether the folder to be accessed is the folder for the participant (step S23). If the folder is the one for the participant (YES at step S23), the access managing portion 105 permits the participant's access to the folder (step S24).

If the folder is not the one for the participant (NO at step S23), the access managing portion 105 denies the participant's access to the folder (step S25).

When the electronic conference is ended (YES at step S26), an electronic conference ending process is executed (step S27). For example, the electronic conference application software 101 and 201 is ended to deny any access to folders.

### Second Embodiment

A second embodiment relates to an electronic conference server apparatus that carries out proper confidentiality management over electronic data accessed at an electronic conference in accordance with an access authority of each participant in the electronic conference, and that carries out proper access management over each piece of electronic data after the end of the electronic conference.

FIG. 7 is a block diagram of an electronic conference server 10′ of the second embodiment. In FIG. 7, the functional blocks having the same functions as that of functional blocks of the electronic conference server 10 of the first embodiment already described in FIG. 2A will be denoted by the same reference numerals to omit the description of such functional blocks. Likewise, the PC 20 already described in FIG. 2B will also be omitted in further description.

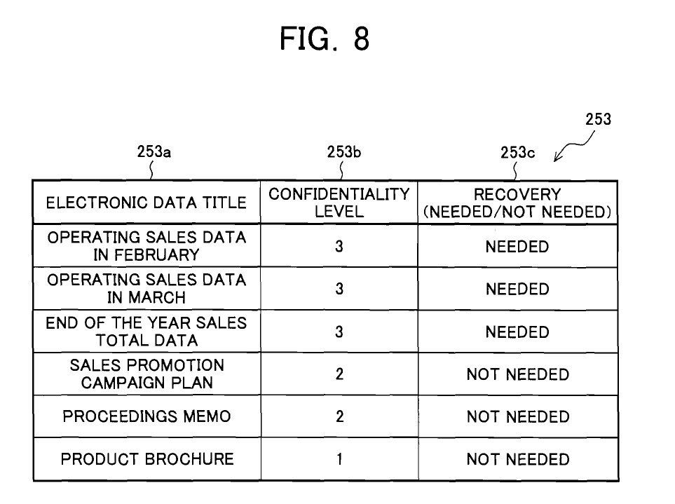

In FIG. 7, 114 denotes an electronic conference data managing portion. The electronic conference data managing portion 114 has a confidentiality level setting portion 114a that sets a confidentiality level for electronic data and a need/needlessness of recovery of the electronic data, and updates and manages a confidentiality level and recovery need/needlessness setting table 253 shown in FIG. 8. Electronic data is recorded on the HDD 110.

### (Confidentiality Level)

A confidentiality level indicates a level of confidentiality management over electronic data, and is set for each piece of electronic data.

The confidentiality level is, for example, information expressed by a numerical value, etc. Here, a larger numerical value represents a higher confidentiality level, that is, a need for strict confidentiality management. A specific example of a confidentiality level will be described later.

### (Setting of Confidentiality Level)

The electronic conference data managing portion 114 executes a process of setting the title of electronic data used at an electronic conference, the tile being input by the conference organizer through a keyboard, mouse, etc., (not shown). In other words, the electronic conference data managing portion 114 sets the title of electronic data in an electronic data title column 253a of the confidentiality level and recovery need/needlessness setting table 253 of FIG. 8.

Then, the confidentiality level setting portion 114a executes a process of setting a confidentiality level, which is input by the conference organizer through the keyboard, mouse, etc., (not shown), for each piece of electronic data. In other words, the confidentiality level setting portion 114a sets the confidentiality level in a confidentiality level column 253b of the setting table 253.

In FIG. 8, the confidentiality level “3” (e.g., level of strict confidence) is set for “operating sales data in February”, the confidentiality level “2” (e.g., level of handle with care) is set for “sales promotion campaign plan”, and the confidential level “1” (e.g., level of normal confidence) is set for “product brochure”, by the organizer.

### (Setting of Need/Needlessness of Recovery)

After the end of an electronic conference, for example, when the organizer of the conference finds the presence of electronic data to which access is to be limited, such as electronic data containing indefinite information, the organizer, having set the above confidentiality level, sets recovery “needed” in a recovery need/needlessness column 253c for the electronic data on the setting table 253.

In the period from the end of the electronic conference to the reopening of the conference, on the other hand, when the organizer finds the presence of electronic data to which access is to be allowed, such as electronic data necessary for discussing a matter placed on the agenda at the conference, the organizer sets recovery “not needed” in the recovery need/needlessness column 253c.

Here, the end of an electronic conference means that the object of the electronic conference is not achieved to lead to reopening of the conference in succession.

115 denotes an access managing portion. The access managing portion 115 has a folder making portion 115a, which will be described later. At an electronic conference, the access managing portion 115 manages the permission and denial of access by a participant in the conference to electronic data based on the correspondence relation between an access authority level and a confidentiality level.

The access managing portion 115 carries out access management so that a participant is allowed to access only the electronic data at a set confidentiality level that is equal to or lower than an access authority level set for the participant.

After the end of the electronic conference, the access managing portion 115 also limits access to electronic data in accordance with whether the electronic data need to be returned or not as set for the electronic data.

The function of the folder making portion 115a is the same as that of the folder making portion 105a of FIG. 2A, and is, therefore, omitted in further description. Likewise, the process of management of access to folders already described in the first embodiment is also omitted in further description.

(Recovery of Electronic Data after End of Electronic Conference)

When an electronic conference is ended, the access managing portion 115 deletes a piece of electronic data set to need to be returned, of electronic data in a folder made for a participant in the conference. Electronic data of which recovery is set “not needed” remains in the folder.

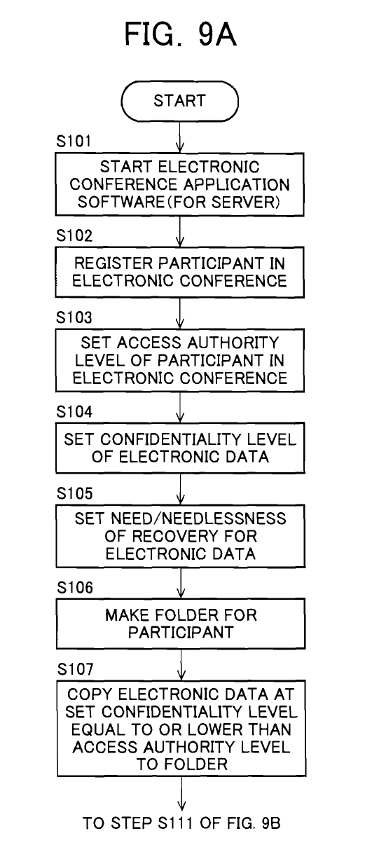

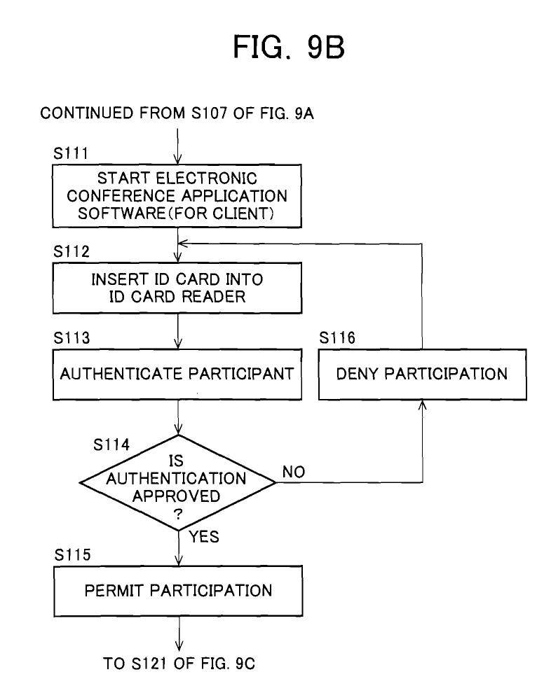

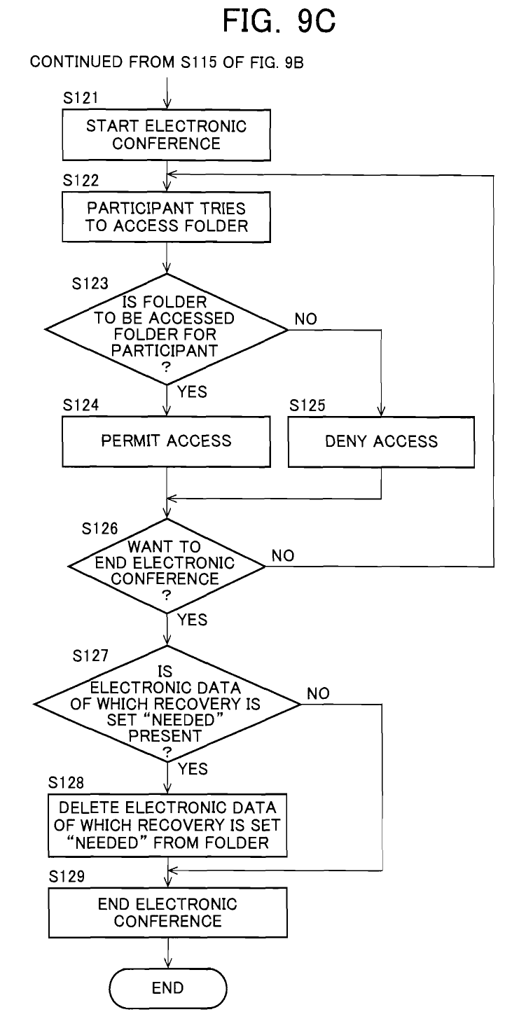

An example of setting of the above mentioned access authority, etc., and access management during an electronic conference and after the end thereof will be described referring to flowcharts of FIGS. 9A to 9C.

The processes carried out at steps S101 to S104 are the same as those carried out at steps S1 to S4 of FIG. 6A, and are, therefore, omitted in further description.

When setting of a confidentiality level for each piece of electronic data is over at step S104, a need/needlessness of recovery is also set for each piece of electronic data (step S105).

This means that the participant registering portion 102, the access authority level setting portion 103a, and the confidentiality level setting portion 114a set the above mentioned prescribed items in the corresponding columns of the participant registering table 151, the access authority level setting table 152, and the confidentiality level and recovery need/needlessness setting table 253, respectively.

Then, the folder making portion 115a of the access managing portion 115 makes a data recording folder for each participant in an electronic conference in the participant data recording portion 106 (step S106), and copies electronic data at a set confidentiality level equal to or lower than an access authority level set for each participant, to the folder made at step S106 (step S107).

The process flow then proceeds to step S111 of FIG. 9B. The processes carried out at steps S111 to S116 of FIG. 9B are the same as those carried out at steps S11 to S16 of FIG. 6B, and are, therefore, omitted in further description.

When authentication of all participants (step S115 of FIG. 9B) is over, the process flow proceeds to step S121 of FIG. 9C, at which the organizer of the electronic conference starts the conference.

The processes carried out at steps S122 to S126 are the same as those carried out at steps S22 to S26 of FIG. 6C, and are, therefore, omitted in further description.

When the electronic conference is over (YES at step S126), in case electronic data of which recovery is set “needed” is present in a folder for a participant (YES at step S127), the electronic data is deleted from the folder (step S128). Then, the electronic conference ending process is executed (step S129), by which process, for example, the electronic conference application software 101 and 201 is ended.

In case electronic data of which recovery is set “needed” is not present in the folder for the participant (NO at step S127), the electronic conference ending process is executed immediately (step S129).

### [Others]

While electronic data itself is copied to a folder in the above embodiments, a shortcut (symbolic link) to electronic data may be made in a folder instead of copying the electronic data itself.

Instead of making a folder for each participant to copy electronic data to the made folder, a folder may be made for each access authority level to copy electronic data to such folder.

This allows a reduction in recording areas.

Instead of allowing the organizer of an electronic conference to set a need/needlessness of data recovery for each piece of electronic data, automatic setting of a need/needlessness of data recovery based on a confidentiality level may be adopted.

Even if a person is denied his/her access to electronic data before or during an electronic conference because the person is not registered with the participant registration table 151, the organizer of the conference may add the person whose participation in the conference is denied to the participant registration table 151 of FIG. 3 as a participant in the conference, and set an access authority level of the added participant on the access authority level setting table 152 of FIG. 4. The participant is then allowed to access electronic data that is limited in access in accordance with the access authority level of the participant, as described above.

Participation in a conference is permitted even during the conference. In such a case, however, if a person is denied his/her participation in the conference, the denial of the person's participation is notified to the PC of the conference organizer to maintain thorough confidentiality. As a result, for example, the monitor screen of the PC 20 may be blacked out to temporarily disable the person from accessing folders or from only the access to electronic data at high confidentiality level.

When the person denied his/her participation leaves the PC 20 or a given time has passed, the blackout of the PC monitor is canceled to allow data access.

Electronic data, such as conference material data, can be made as needed not only before a conference but also during the conference.

When electronic data is made anew, the conference organizer sets a confidentiality level for the made electronic data, as described above, and then the electronic data is copied to a folder for which an access authority level equal to or higher than the set confidentiality level is set.

In the case of the electronic conference server 10′ of the second embodiment, the conference organizer sets a confidentiality level and a need/needlessness of recovery for the made electronic data, and then the electronic data is copied to a folder for which an access authority level equal to or higher than the set confidentiality level is set.

Permission/nonpermission to printing of electronic data can also be managed. To achieve this management, a column for setting permission/nonpermission to printing for each piece of electronic data is made on the confidentiality level setting table 153 of FIG. 5, and permission/nonpermission to printing of electronic data may be managed based on this setting.

In the case of the electronic conference server 10′ of the second embodiment, to achieve the above management, a column for setting permission/nonpermission to printing for each piece of electronic data is made on the confidentiality level and recovery need/needlessness setting table 253 of FIG. 8, and permission/nonpermission to printing of electronic data may be managed based on this setting.

An access authority level and a confidentiality level may be expressed as information other than a numerical value, such as character information of H, M, L, etc.

The electronic conference server 10 may be incorporated into an image forming apparatus.

The electronic conference managing portion 103 and the electronic conference data managing portion 104 may be separated from the electronic conference server 10 as independent units, and be provided separately as an electronic conference management server and an electronic conference data management server.

Likewise, the participant registering portion 102 and the participant authenticating portion 107 may be separately provided as a participant registering server and an authenticating server.

The access managing portion 105 and the participant data recording portion 106 may also be separately provided as an access management server and a storage server.

This leads to the dispersion of process load, thus improves processing speed.

After the electronic conference is finished completely, that is, when the whole objects of the conference are achieved and the conference is not scheduled to be opened any more, access to folders is forbidden in principle.

According to the present invention, access management is carried out properly based on an access authority of each participant in an electronic conference in accordance with a confidentiality level set for electronic data used at the electronic conference. This reduces a risk of leaking electronic data at a high confidentiality level.

According to the present invention, proper access management is carried out for each piece of electronic data after the end of an electronic conference. This offers improved convenience for the organizer and participants at the electronic conference.

1. An electronic conference server apparatus comprising:
an access authority level setting portion that sets an access authority level in access to electronic data used at an electronic conference for each participant in the electronic conference;
a confidentiality level setting portion that sets a confidentiality level for each piece of electronic data used at the electronic conference; and
an access managing portion that manages permission and denial of access to the electronic data based on a correspondence relation between the access authority level and the confidentiality level, wherein
at the electronic conference, the participant's access to the electronic data is limited in accordance with the access authority level set for the participant.

2. The electronic conference server apparatus as defined in claim 1, further comprising:
a participant registering portion that registers a participant in an electronic conference; and
a participant authenticating portion that authenticates a participation qualification of a person who intends to participate in the electronic conference based on presence/absence of registration of the person with the participant registering portion, wherein
only the person whose participation qualification is authenticated is allowed to access the electronic data everytime an electronic conference is held.

3. The electronic conference server apparatus as defined in claim 2, wherein
when a person not registered with the participant registering portion tries to access the electronic data, if the access authority level setting portion sets an access authority level for the person, the person is allowed to access the electronic data that is limited in access in accordance with the set access authority level.

4. The electronic conference server apparatus as defined in claim 1, wherein
the access managing portion makes a folder for each participant in the electronic conference as a folder accessible only by the participant, and copies the electronic data limited in access in accordance with the access authority level set for the participant, to the folder.

5. The electronic conference server apparatus as defined in claim 1, wherein
the access managing portion permits access to the electronic data only during an electronic conference.

6. An electronic conference system comprising:
the electronic conference server apparatus as defined in claim 1; and
an electronic conference terminal device connected to the electronic conference server apparatus via a network, the terminal device transmitting input personal information of the participant in the electronic conference to the electronic conference server apparatus.

7. An electronic conference server apparatus comprising:
an access authority level setting portion that sets an access authority level in access to electronic data used at an electronic conference for each participant in the electronic conference;
a confidentiality level setting portion that sets a confidentiality level and a need/needlessness of electronic data recovery for each piece of electronic data used at the electronic conference; and
an access managing portion that manages permission and denial of access to the electronic data based on a correspondence relation between the access authority level and the confidentiality level, wherein
at the electronic conference, the participant's access to the electronic data is limited in accordance with the access authority level set for the participant, and wherein
after the end of the electronic conference, the access to the electronic data is limited in accordance with whether the electronic data need to be returned or not as set for the electronic data.

8. The electronic conference server apparatus as defined in claim 7, further comprising:
a participant registering portion that registers a participant in an electronic conference; and
a participant authenticating portion that authenticates a participation qualification of a person who intends to participate in the electronic conference based on presence/absence of registration of the person with the participant registering portion, wherein
only the person whose participation qualification is authenticated is allowed to access the electronic data everytime an electronic conference is held.

9. The electronic conference server apparatus as defined in claim 8, wherein
when a person not registered with the participant registering portion tries to access the electronic data, if the access authority level setting portion sets an access authority level for the person, the person is allowed to access the electronic data that is limited in access in accordance with the set access authority level.

10. The electronic conference server apparatus as defined in claim 7, wherein
the access managing portion makes a folder for each participant in the electronic conference as a folder accessible only by the participant, and copies the electronic data limited in access in accordance with the access authority level set for the participant, to the folder.

11. The electronic conference server apparatus as defined in claim 7, wherein
the access managing portion permits access to the electronic data only during an electronic conference.

12. The electronic conference server apparatus as defined in claim 7, wherein
the access managing portion makes a folder for each participant in the electronic conference as a folder accessible only by the participant, copies the electronic data limited in access in accordance with the access authority level set for the participant, to the folder, and, after the end of the electronic conference, deletes a piece of electronic data set to need to be returned, of the electronic data in the folder.

13. The electronic conference server apparatus as defined in claim 12, wherein
the access managing portion forbids access to the folder after the electronic conference is finished completely.

14. An electronic conference system comprising:
the electronic conference server apparatus as defined in claim 7; and
an electronic conference terminal device connected to the electronic conference server apparatus via a network, the terminal device transmitting input personal information of the participant in the electronic conference to the electronic conference server apparatus.
